(19) United States
(12) Patent Application Publication
(10) Pub. No.: US 2005/0038703 A1
(43) Pub. Date: Feb. 17, 2005

(54) Contents sales method and system

(75) Inventors: Makoto Toki, Sendai (JP); Kazuhiko Kujibayashi, Sendai (JP); Yoshiteru Itou, Sendai (JP); Tuyoshi Nara, Sendai (JP); Tomoyuki Takoshima, Sendai (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/942,525

(22) Filed: Sep. 16, 2004

Related U.S. Application Data
(63) Continuation of application No. PCT/JP02/02692, filed on Mar. 20, 2002.

(51) Int. Cl. G06F 17/60

(52) U.S. Cl. 705/14

(57) ABSTRACT

When receiving information to specify a purchase portion of contents that are priced so that a portion whose sales unit price gradually increases from a sales unit price of an initial portion exists, and a purchase instruction from a terminal of a purchaser, information concerning a purchase range of the contents and price information is stored into a storage device so as to correspond to the purchaser, and data for the purchase portion of the contents is transmitted to the purchaser. Thus, following benefits are obtained by carrying out not the simple tally trade, but a tally trade of the contents under the price setting in which the sales unit price gradually increases from the initial portion of the contents, for instance. That is, (a) the purchaser can firstly purchase portions of the contents at a low price, and when he or she judges at an early stage that he or she does not like them, and stops their purchase, the cost can be lowered as a whole, and he or she can tentatively read a lot of books. And, (b) the contents seller can obtain the same sales as the conventional one, when the purchaser buys the entire contents, and even if the purchaser stopped his or her purchase halfway, the contents seller can obtain the sales up to the purchased portions. Furthermore, there is a benefit in which the cost can be suppressed to very lower price than selling goods.

### CROSS-REFERENCE TO RELATED APPLICATIONS

This application is a continuing application, filed under 35 U.S.C. section 111(a), of International Application PCT/JP02/02692, filed Mar. 20, 2002.

### TECHNICAL FIELD OF THE INVENTION

This invention relates to an online sales technique for contents.

### BACKGROUND OF THE INVENTION

For example, in a book sales site in the Internet, a sales increase is achieved by using various sales promotion techniques. For example, they includes the provision of a book search function by keywords, provision of book reviews, provision of points according to the purchase amount, free delivery charge, discount, or the like.

However, in the online book sales, it is impossible to purchase books after the confirmation of the book contents as if the customer were in an actual bookstore. In the actual bookstore, the customer often takes an action to purchase a book, when he or she takes the actual book in his or her hand to see it, and confirms its contents in some degree, and his or her buying intention is excited. That is, because the customer cannot confirm the book contents in the service provided in the conventional book sales site, it is impossible to excite the buying intention for books other than books that are predetermined to be purchased in some reasons, books written by favorite authors, books in the news or the like.

### SUMMARY OF THE INVENTION

Therefore, an object of this invention is to provide a technique to effectively excite the customer's buying intention in the online sales of contents including books, movies, sound data, games and the like.

A contents tally trade method according to a first aspect of this invention comprises: when receiving information to specify a purchase portion of contents that are priced so that a portion whose sales unit price gradually increases from a sales unit price of an initial portion exists, and a purchase instruction from a terminal of a purchaser, registering information concerning a purchase range of the contents and price information into a storage device so as to correspond to the purchaser; and transmitting data for the purchase portion of the contents to the purchaser. Thus, following benefits are obtained by carrying out not the simple tally trade, but a tally trade of the contents under the price setting in which the sales unit price gradually increases from the initial portion of the contents, for instance. That is, (a) the purchaser can firstly purchase portions of the contents at a low price, and when he or she judges at an early stage that he or she does not like them, and stops their purchase, the cost can be lowered as a whole, and he or she can tentatively read a lot of books. In addition, (b) the contents seller can obtain the same sales as the conventional one, when the purchaser buys the entire contents, and even if the purchaser stopped his or her purchase halfway, the contents seller can obtain the sales up to the purchased portions. Furthermore, there is a benefit in which the cost can be suppressed to very lower price than selling goods.

Incidentally, the information to specify the purchase portion of the contents may include information of a purchase price, and the aforementioned registering may comprise computing the information concerning the purchase range of the contents from the information of the purchase price and information concerning a price setting of the contents.

In addition, the information to specify the purchase portion of the contents may include the information concerning the purchase range of the contents, and the aforementioned registering may include computing price information of the contents from the information concerning the purchase range of the contents and the information concerning the price setting of the contents.

Further, the contents tally trade method may further comprise: by using the information concerning the purchase range of the contents, which is registered in the storage device, transmitting information concerning the last purchase range or information concerning the purchase range up to the last purchase, to the terminal of the purchaser. As a result, the purchaser can determine the purchase range for this time while taking into account the last purchase range or the purchase range up to the last purchase.

In addition, the contents tally trade method may further comprise: transmitting to the terminal of the purchaser, information to display a price graph based on the price setting of the contents and the purchase range up to the last purchase by using the price graph and the information concerning the purchase range of the contents, which is registered in the storage device. As a result, the purchaser can determine the purchase range for this time while taking into account the price and the purchase range up to the last purchase.

Furthermore, the contents tally trade method may comprise: transmitting to the terminal of the purchaser, data to prompt the purchase of the contents, wherein the data enables to specify portions after the purchase range up to the last purchase as the information to specify the purchase portion of the contents by using the information concerning the purchase range of the contents, which is registered in the storage device. As a result, it becomes possible for the customer to specify the purchase portion for this time more easily.

A contents purchase method according to a second aspect of this invention comprises: receiving from a contents sales server and displaying on a display device, information concerning a price setting of purchase-desired contents that are priced so that a portion whose sales unit price gradually increases from a sales unit price of an initial portion exists, and information concerning a purchase range up to the last purchase of the purchase-desired contents; accepting from a user and transmitting to the contents sales server, information to specify a purchase portion of the purchase-desired contents; and receiving the purchase portion of the purchase-desired contents, which is generated by the contents sales server. As a result, the customer can determine the purchase range for this time while referring to the price and the purchase range up to the last purchase. Therefore, the usability is enhanced.

A contents sales setting method according to a third aspect of this invention comprises: when receiving a registration request of sales contents from a terminal of a seller, transmitting data to prompt a price setting of the sales contents to the terminal of the seller; and when receiving instruction information of the price setting for the sales contents, in which a portion whose sales unit price gradually increases from a sales unit price of an initial portion exists, storing the information concerning the price setting for the sales contents.

Incidentally, the contents sales setting method may further comprise: transmitting to the terminal of the seller, model data for price curves of the sales contents, which includes a price curve of the price setting in which a portion whose sales unit price gradually increases from a sales unit price of an initial portion exists. By such a configuration, it becomes possible for the seller to carry out the price setting more easily.

In addition, the aforementioned instruction information of the price setting for the sales contents may include instruction information of a parameter of the price curve, and the contents sales setting method may further comprise: transmitting to the terminal of the seller, data to prompt an instruction for the parameter of the price curve. This is to enable the fine adjustment of the price from the model price curve.

A contents sales setting method according to a fourth aspect of this invention comprises: receiving data to prompt a price setting of sales contents from a contents sales server that is a transmission destination of a registration request of the sales contents; and accepting from a seller and transmitting to the contents sales server, information for the price setting for the sales contents, in which a portion whose sales unit price gradually increases from a sales unit price of an initial portion of the sales contents exists. As a result, the contents seller can carry out the price setting in which a portion whose sales unit price gradually increases from a sales unit price of an initial portion exists, for instance, and can obtain the aforementioned benefits.

Incidentally, it is possible to create a program causing a computer to execute the method according to the first and third aspect of this invention, and the program is stored in a storage medium or storage device, such as a floppy disk, CD-ROM, magneto-optic disk, semiconductor memory, hard disk or the like. In addition, it may be distributed via a network. Incidentally, intermediate processing data is temporarily stored into a memory of the computer.

### BRIEF DESCRIPTION OF THE DRAWINGS

FIG. 1 is a system diagram according to one embodiment of this invention;

FIG. 2 is a diagram showing an example of data stored in a product master DB;

FIG. 3 is a diagram showing an example of data stored in an inclined price master DB;

FIG. 4 is a diagram showing an example of data stored in a purchase history master DB;

FIG. 5 is a diagram showing an example of data stored in a member master DB;

FIG. 6 is a diagram showing an example of data stored in a purchase master DB;

FIG. 7 is a diagram showing a processing flow when registering information of contents (books) for sale;

FIG. 8 is a diagram showing an example of a product information registration screen;

FIG. 9 is a diagram showing an example of a screen of an inclined price information registration;

FIG. 10 is a diagram showing a processing flow to carry out a price setting for the contents;

FIG. 11 is a diagram showing an example of a screen for a price change graph reference;

FIG. 12 is a diagram showing an example of a price curve;

FIG. 13 is a diagram showing a processing flow (part 1) at the sale of the contents;

FIG. 14 is a diagram showing an example of a product information list screen;

FIG. 15 is a diagram showing an example of a screen for product information details;

FIG. 16 is a diagram showing a processing flow (part 2) at the sale of the contents;

FIG. 17 is a diagram showing an example of a screen for a partition purchase;

FIG. 18 is a diagram showing a processing flow when calculating a purchase price from an purchase page designation;

FIG. 19 is a diagram showing a processing flow when calculating purchase pages from purchase price designation; and

FIG. 20 is a diagram showing a processing flow of a product transmission processing.

### BEST MODE TO CARRYING OUT THE INVENTION

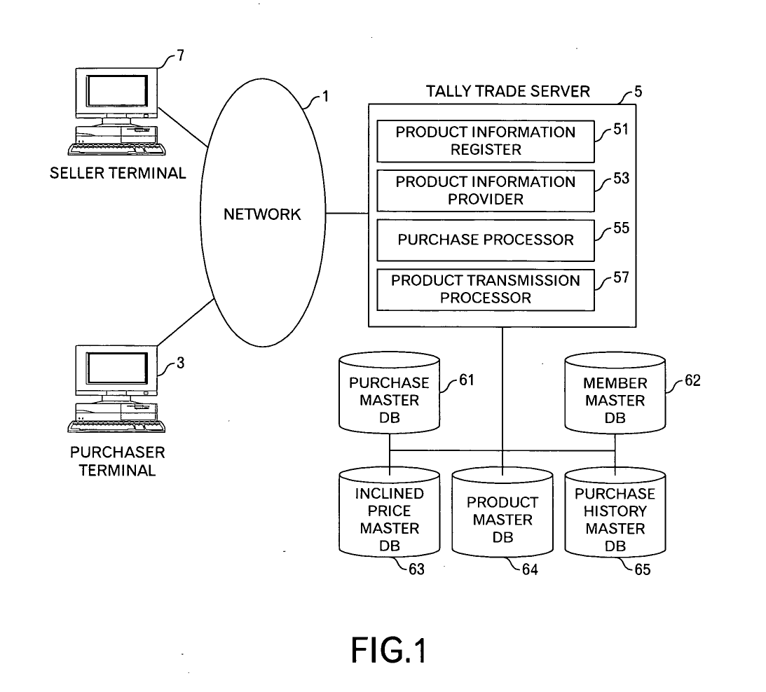

FIG. 1 shows a system outline diagram according to an embodiment of this invention. For example, a network 1 as the Internet is connected to one or plural seller terminals 7 that are personal computers, for example, and have a Web browser function, one or plural purchaser terminals 3 that are personal computers, for example, and have a Web browser function and mailer function, a tally trade server 5 that carries out a main processing in this embodiment and has a Web server function. The tally trade server 5 is a server to carry out the sale of contents, and has a product information register 51 to register information of products, which are contents such as books, movies, sound data, games and the like, product information provider 53 to provide product information in response to a request from the purchaser terminal 3, purchase processor 55 to carry out a purchase processing in response to an instruction from the purchaser terminal 3, and product transmission processor 57 to transmit information of the contents as a product purchased by the purchaser. In addition, the tally trade server 5 manages a purchase master DB 61 used for a settlement processing, member master DB 62 to register information of the purchasers as members, inclined price master DB 63 storing information concerning the price setting of the contents, product master DB 64 storing the basic information of the contents as a product, and purchase history master DB 65 to register the purchase history of a purchaser. In the following, an explanation for books as contents will be carried out as an example.

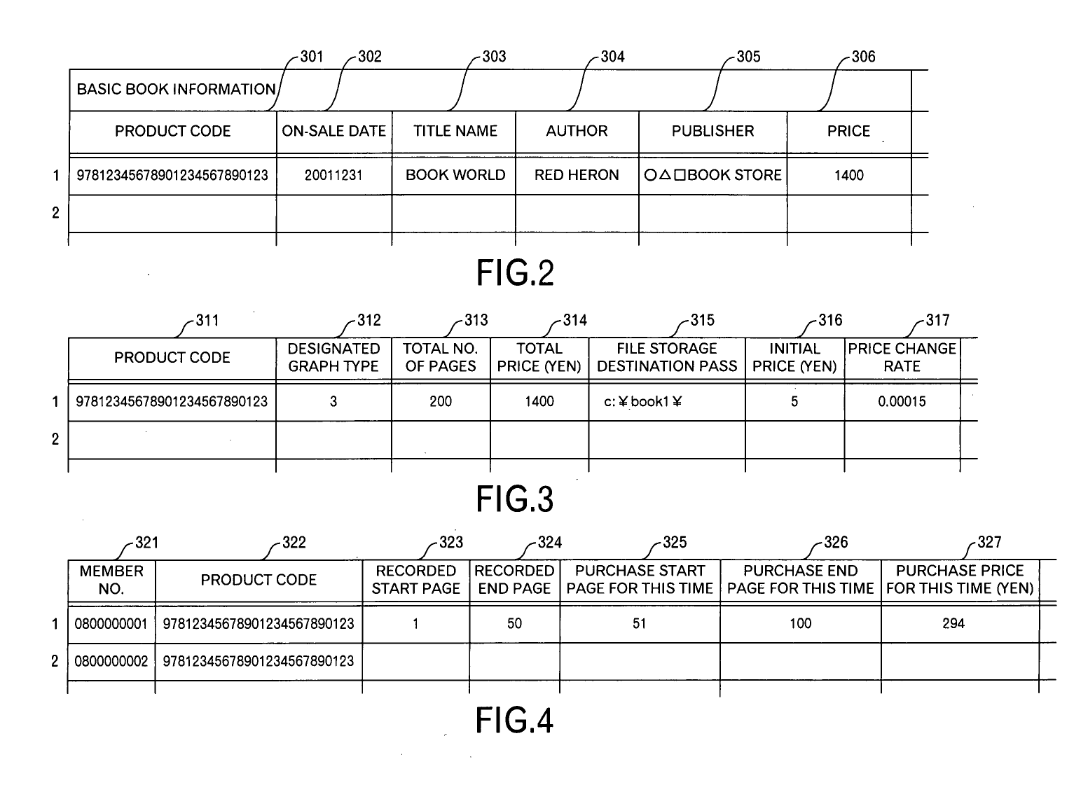

FIG. 2 shows an example of data stored in the product master DB 64. In an example of FIG. 2, a column 301 of product codes, column 302 of on-sale dates, column 303 of title names, column 304 of authors, column 305 of publishers, and column 306 of prices are provided. However, basic book information other than this may be registered. For example, book reviews and/or simple guidance may be registered.

FIG. 3 shows an example of data stored in the inclined price master DB 63. In an example of FIG. 3, a column 311 of product codes, column 312 of designated graph types representing which price system is set, column 313 of the total numbers of pages, column 314 of total prices (Yen), column 315 of file storage destination passes representing storage destination of data of the book as a product, column 316 of initial prices (Yen) as one parameter for the price setting, and column 317 of price change rates as one parameter for the price setting are included. As for the designated graph type, “1” for the simple increase, “2” for a curve approximated to a tertiary function, “3” for a curve approximated to a quadric, or “4” for no change is set. Incidentally, in this embodiment, 4 kinds of price curves are set, but more or less price curves may be set. In addition, as for the parameters for the price setting, more data may be stored.

FIG. 4 shows an example of data stored in the purchase history master DB 65. In an example of FIG. 4, a column 321 of member numbers (Nos.), column 322 of product codes, column 323 of recorded start page numbers as purchase history data for the last time, column 324 of recorded end page numbers as the purchase history data for the last time, column 325 of purchase start page numbers for this time as purchase result data for this time, column 326 of purchase end page numbers for this time as the purchase result data for this time, and column 327 of purchase prices (Yen) for this time as the purchase result data for this time are provided.

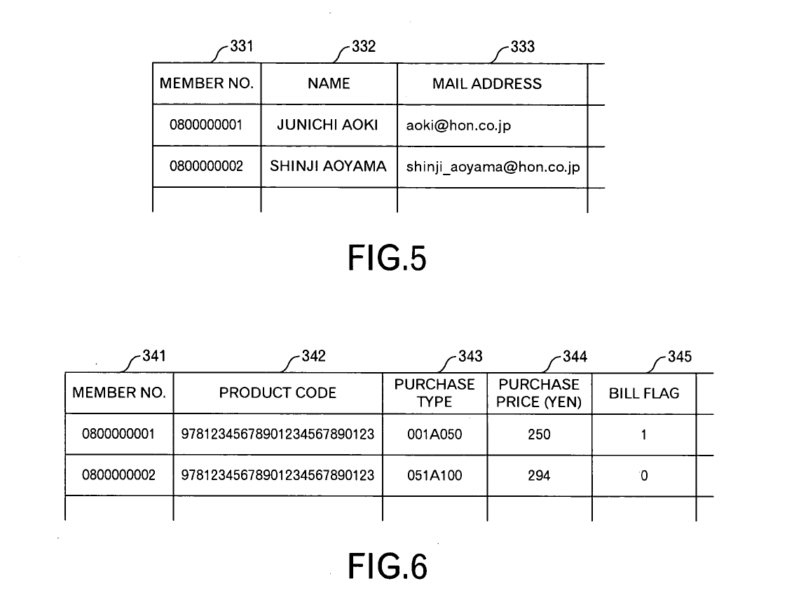

FIG. 5 shows an example of data stored in the member master DB 62. In an example of FIG. 5, a column 331 of member numbers (Nos.), column 332 of names, column 333 of mail addresses as transmission destinations of data of the purchased book in this embodiment are provided. Furthermore, other information may be included. For example, other information may include information for the settlement, address, other personal attributes.

FIG. 6 shows an example of data stored in the purchase master DB 61. In an example of FIG. 6, a column 341 of member numbers (Nos.), column 342 of product codes of purchased books, column 343 of purchase types, column 344 of purchase prices (Yen), and column 345 of bill flags are included. The purchase type is composed of “purchase start page number”+“A”+“purchase end page number”. That is, “001A050” indicates a case in which pages from 1 to 50 have been purchased. In addition, the bill flag represents “1” for paid (or receipt), and “0” for not paid (not receipt).

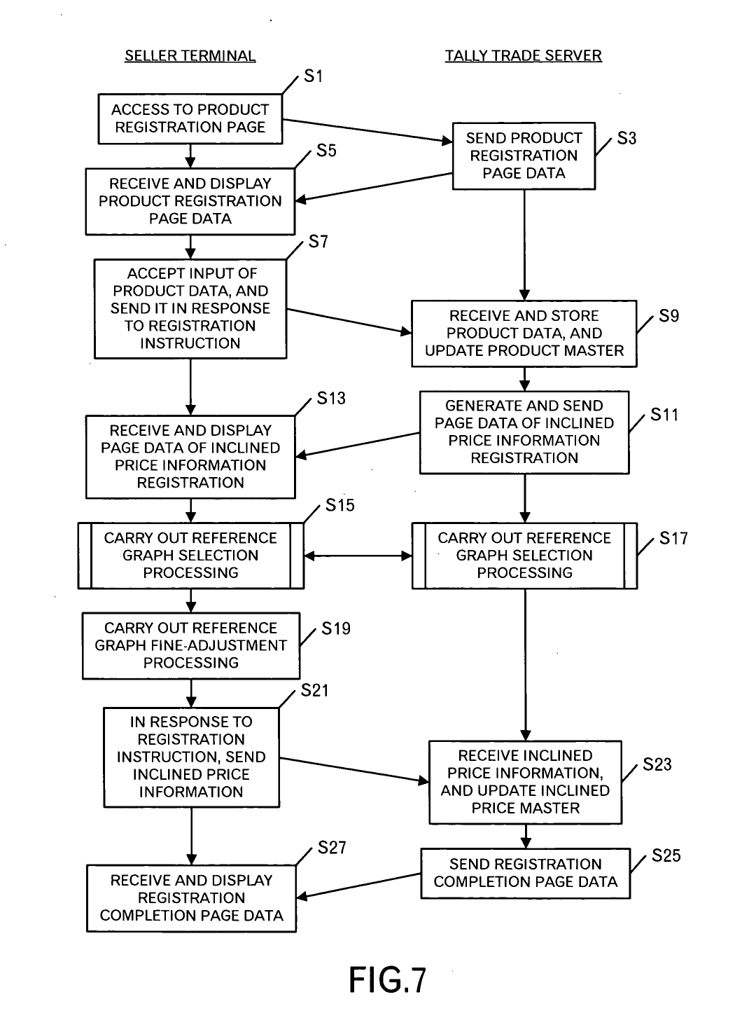

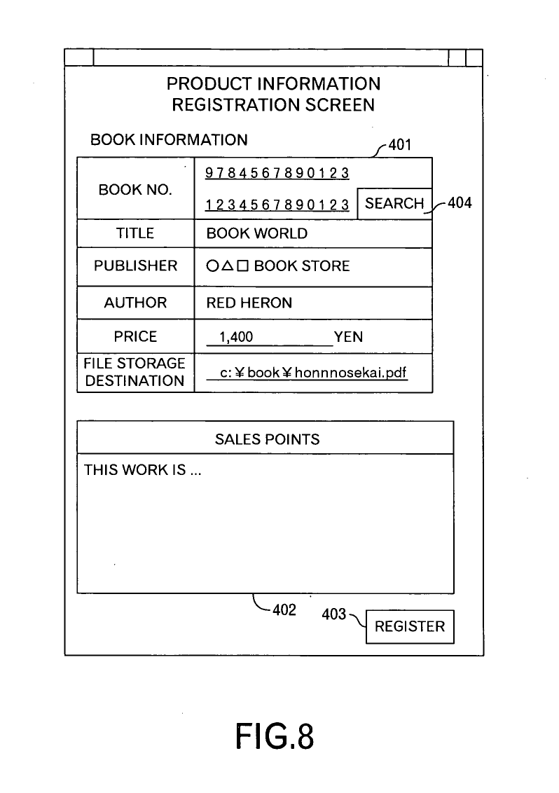

Next, a processing flow of the system shown in FIG. 1 will be explained using FIGS. 7 to 20. First, a processing when the seller operates the seller terminal 7 to register data of books that are desired to sell, into the tally trade server 5 will be explained using FIGS. 7 to 12. First, the seller operates the seller terminal 7 to access a product registration page in the tally trade server 5 (step S1). In response to the access from the seller terminal 6, the product information register 51 of the tally trade server 5 transmits product registration page data (for example, a file written in a markup language such as Hyper Text Markup Language (HTML), and/or image files associated with the file) to the seller terminal 7 (step S3). When receiving the product registration page data from the tally trade server 6, the seller terminal 7 displays it on a display device by the Web browser (step S5). For example, a screen as shown in FIG. 8 is displayed.

In an example of FIG. 8, a book information input table 401 including a input column of a book number (No.), input column of a title, input column of a publisher, input column of an author, input column of a price, input column of a local file storage destination as a file retrieval source, and search button 404, sales point input column 402, and register button 403 are included. Incidentally, the search button 404 is to search the product master DB 64 via the tally trade server 5 using the book number and to read out information such as a title, publisher, author and the like. Incidentally, such a search is normally carried out and the explanation is omitted, here.

The seller inputs information of the book number, title, publisher, author, price and file storage destination, and information of sales points into respective input columns, according to the screen as shown in FIG. 8, for instance, and clicks the register button 403.

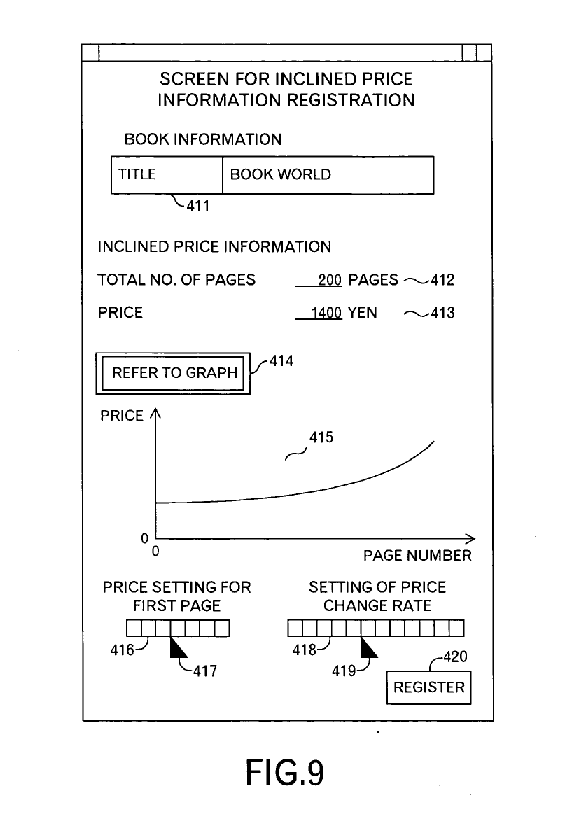

Then, the seller terminal 7 accepts the input of the product data from the seller, and in response to a registration instruction by the click of the register button 403, it transmits input product data to the tally trade server 5 (step S7). At this time, it reads out a file according to the file name input in the input column of the file storage destination, and transmits the file as a part of the product data to the tally trade server 5. The product information register 51 of the tally trade server 5 receives the product data from the seller terminal 7 and temporarily stores it into a storage device. Then, it updates the product master DB 64 by using the received product data (step S9). In addition, it receives the file including the book data together, and stores the book data file in a predetermined directory. The name of this storage destination directory is registered in the inclined price master DB 63 as a file storage destination pass. In addition, it generates page data of the inclined price information registration for the product (step S11). The seller terminal 7 receives the page data of the inclined price information registration from the tally trade server 5 by the Web browser (step S13). For example, a screen as shown in FIG. 9 is displayed.

In an example of FIG. 9, a display column 411 of a title as information of the book for which the product data is registered for this time, input column 412 of the total number of pages as the inclined price information, price input column 413, price graph reference button 414 to select a price graph, price graph display part 415, price setting part 416 for the first page, price change rate setting part 418, price change rate setting lever 419, and register button 420 to register input or selected information are included. In the price input column 413, the price input in the screen shown in FIG. 8 is displayed as it is, but it is also possible to change it on this screen. In addition, in the price graph display part 415, the vertical axis represents the unit price, and the horizontal axis represents the page number. In an example of FIG. 9, the price curve is a curve in which the unit price is gradually increased from the first page. However, although the details are described later, it is possible to select an appropriate price curve for the product to be registered at this time among several model curves in a screen displayed after the click of the price graph reference button 414. In addition, even if an appropriate model curve is selected, there is a case where an adjustment is necessary to some extent. Therefore, the price curve is adjusted by the price setting part 416 for the first page and price change rate setting part 418. Incidentally, the price setting part 416 for the first page and price change rate setting part 418 are displayed only in a case where it is necessary to adjust these parameters. For example, in a case where the page unit price is not changed, the adjustment cannot be carried out. Furthermore, in a case where parameters necessary to adjust increase, more setting parts are displayed. In addition, first, any price curve is not selected, therefore, any price curve may not be displayed on the price graph display column 415, and the curve in which the sales unit price gradually increases from the first page as shown in FIG. 9, for example, may be initially selected and displayed.

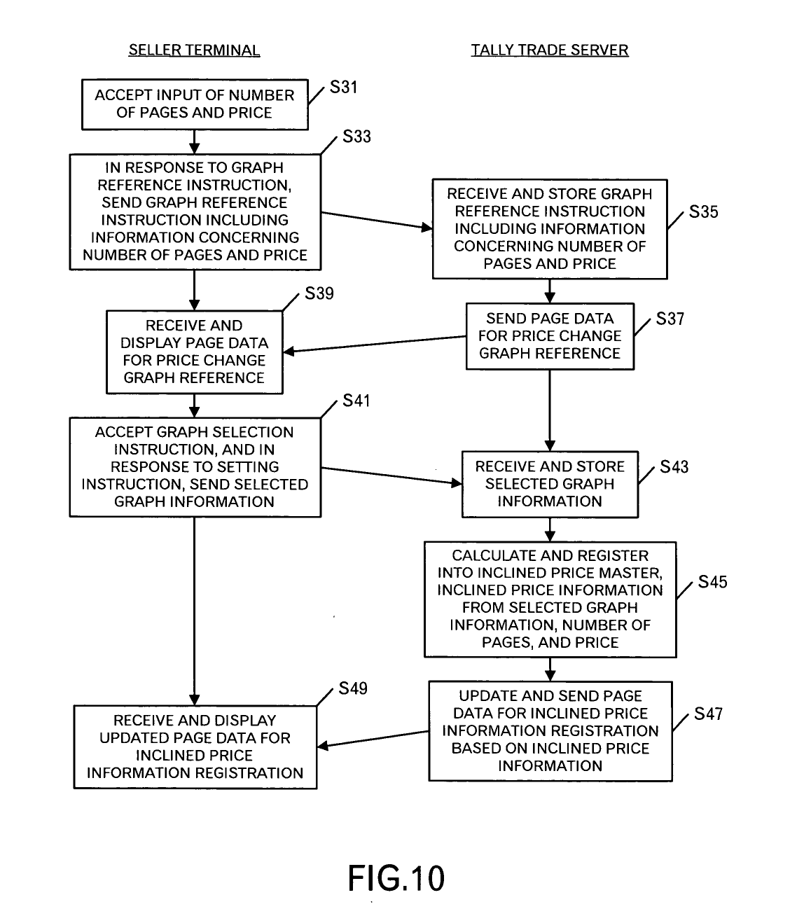

It is assumed that the seller inputs the number of pages and price, and clicks the price graph reference button 414 to select an appropriate model curve on the screen being displayed as shown in FIG. 9. Then, the seller terminal 7 and tally trade server 5 carry out a reference graph selection processing (steps S15 and S17). As for this processing, the details are explained using FIG. 10.

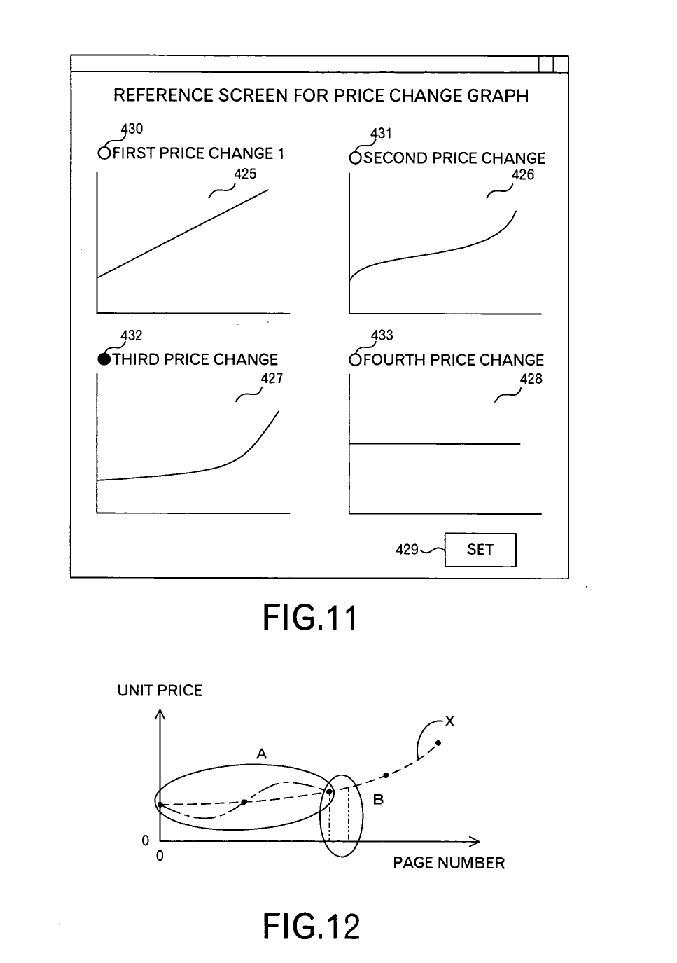

The seller terminal 7 accepts inputs of the number of pages and price by the seller (step S31 in FIG. 10), and in response to the click of the price graph reference button 414, it transmits an graph reference instruction including information concerning the number of pages and price to the tally trade server 5 (step S33). The product information register 51 of the tally trade server 5 receives the graph reference instruction including information concerning the number of pages and price from the seller terminal 7, and temporarily stores it into a storage device (step S35). Then, the product information register 51 transmits page data for the price change graph reference to the seller terminal 7 (step S37). The seller terminal 7 receives the page data for the price change graph reference, and display it on the displays device by the Web browser (step S39). For example, a screen as shown in FIG. 11 is displayed.

In an example of FIG. 11, a display part 425 of the first price change graph, display part 426 of the second price change graph, display part 427 of the third price change graph, display part 428 of the fourth price change graph, and set button 429 are included. Here, radio buttons 430 to 433 to select one among these four graphs are provided. In the example of FIG. 11, the first price change graph is a graph for the simple increase. The price change graph is a graph, which is approximated to the tertiary function, and represents a price setting in which the price of the first introduction portion is cheap, and the price of the intermediate portions is hardly changed, and the price of the epilogue portion becomes expensive. Such a price setting can be applied to a work like a drama. In addition, the second price change graph is a graph, which is approximated to a quadratic, and represents a price setting in which the page unit price gradually increases from the first page, and the price increase rate becomes high in the epilogue portion. For example, it can be applied to mysteries or the like in which the epilogue portion is important. The fourth price change graph represents a price setting in which there is no price change. Except the fourth price change graph, the page unit price of the initial portion is set to cheap, and the price curve is used in which the obstacle to the purchase start is lowered, and the purchase is encouraged as much as possible.

Incidentally, when the total price and the number of pages are determined, the fourth price change graph is uniquely determined. But the first to third price change graphs are not uniquely determined. Therefore, in the processing explained later, parameters for the straight line or curve have to be determined.

The seller looks at the screen as shown in FIG. 11, selects a price change graph appropriate for the book to be registered for this time, clicks any one of the radio buttons, and clicks the set button 429. The seller terminal 7 accepts a graph selection instruction by the click of the radio button from the seller, and in response to a setting instruction by the click of the set button 429, it transmits the selected graph information to the tally trade server 5 (step S41). The product information register 51 of the tally trade server 5 receives the selected graph information from the seller terminal 7, and temporarily stores it into a storage device (step S43). Then, it calculates the inclined price information from the selected graph information, the number of pages, and the price (step S45).

Here, the inclined price information is explained. The inclined price information includes parameters to determine the price curve, such as a price for the first page (initial price) and price change rate. When it is the straight line, it is represented by
f(x)=ax+b (1).
Therefore, it is fixed by the initial price b and price change rate a. In addition, as for the quadric as shown in FIG. 11, because it is represented by
f(x)=ax²+b (2)
it is fixed by the initial price b and price change rate a. Here, when the total price of the book is p, and the total number of pages is n, the following equation is established.
∫₀ⁿf(x)dx=p (3)
Therefore, if either of the initial price b and price change rate a is fixed, the other is fixed. When the quadric is used for an example, in a case where the set initial price is b₁, it can be expressed by
f₁(x)=ax²+b, (4)
and furthermore, also in
∫₀ⁿf₁(x)dx=p (5)
n and p are already determined. Therefore, the price change rate a can be calculated. Similarly, when the price change rate is determined as a₁, it can be expressed by
f₂(x)=a₁x²+b (6)
and furthermore, also in
∫₀ⁿf₂(x)dx=p (7)
n and p are already determined, and it is possible to calculate the initial price b. Here, although the quadric has been explained, the basic way of thinking is the same even if it is a linear function or a tertiary function.

Because any designation for the initial price b, price change rate a, or the like is not still carried out at the step S45, the initial price b is firstly given, for example, and the price change rate a is calculated, and the initial price b and price change rate a are registered in the inclined price master DB 63.

Then, the product information register 51 updates the page data for the inclined price information registration based on the inclined price information, and transmits the updated page data for the inclined price information registration to the seller terminal 7 (step S47). Incidentally, in the updated page data for the inclined price information registration, the form of the price change graph selected in the FIG. 11 and the price graph determined based on the inclined price information provisionally calculated are embedded into the price graph display part 415, and if necessary, the price setting part 416 for the first page and price change rate setting part 418 are included. Incidentally, for the further following processing, there is a case where an Java (trade mark of Sun Microsystems Inc.) applet or the like is transmitted simultaneously in which a lever 417 in the price setting part 416 for the first page or lever 419 in the price change rate setting part 418 is made movable, and according to the instruction for the lever 417 or 419 by the seller, the display in the price graph display part 415 is changed.

The seller terminal 7 receives the updated page data for the inclined price information registration from the tally trade server 5, and displays it on the display device by the Web browser (step S49). Here, for example, a screen as shown in FIG. 9 is displayed. Incidentally, by displaying numerals corresponding to the initial inclined price information on scales of the price setting part 416 for the first page and/or the price change rate setting part 418, the seller can carry out the fine adjustment more easily. By such a processing, the reference graph selection processing (steps S15 and S17) are carried out. The seller can determine the price curve that becomes an origin for the desired price setting more easily by this processing.

Returning to the explanation for FIG. 7, the seller looks at the screen as shown in FIG. 9, and carries out the fine adjustment for the inclined price information by using the price setting part 416 for the first page and/or price change rate setting part 418. The seller terminal 7 carries out a reference graph fine-adjustment processing according to instructions from the seller (step S19). For example, when the initial price (price for the first page) is changed, it is possible that the Java applet or the like re-calculates the price change rate according to the change, changes the display of the price graph display part 415, and displays a new price change rate near the price change rate setting part 418. When the price change rate is changed, it is possible to re-calculate the initial price, change the display of the price graph display part 415, and display a new initial price near the price setting part 416 for the first page. In FIG. 9, although input columns to directly set numerals are not provided, it is possible to provide such input columns to directly set numerals and to make the seller input them. Here, although the inclined price information including the initial price and price change rate is finely adjusted by the Java applet, Java script or the like only in the seller terminal 7, it is possible to send the result of the fine adjustment to the product information register 51 of the tally trade server 5 when any instructions by the lever 417 or 419 are carried out, and to update the page data for the inclined price information registration.

When the seller has carried out such a fine adjustment, and has set the desired price curve, he or she clicks the register button 420 in FIG. 9. Then, in response to the click of the register button 420, the seller terminal 7 obtains information such as the initial price, price change rate and the like, and transmits the inclined price information including them to the tally trade server 5 (step S21). The product information register 51 of the tally trade server 5 receives the inclined price information from the seller terminal 7, and updates the inclined price master DB 63 by the received inclined price information (step S23). Incidentally, there is a case in which before the registration to the inclined price master DB 63, it is confirmed whether or not there is inconsistency among the received inclined price information, the total number of pages and the total price.

Finally, the product information register 51 of the tally trade server 5 generates registration completion page data, and transmits it to the seller terminal 7 (step S25). The seller terminal 7 receives the registration completion page data from the tally trade server 5, and displays it on the display terminal by the Web browser (step S27).

By carrying out the processing as described above, the seller can register the product desired to sell, can perform the tally trade of the contents, and can carry out the desired price setting. Incidentally, the number of price change graphs selectable in FIG. 11 is arbitrary, and it is possible that more or less graphs are presented to make the seller select. In this embodiment, by relatively lowering the price for the initial portion, the burden for the purchaser at the beginning of the subscription is lowered, and the purchase by more purchasers is encouraged. In addition, the price for the ending portion is raised on behalf of lowering the price for the initial portion. It is possible that not only the price curve is simply set so as to gradually increase but also the price for the first page or a page or pages in the middle portion is set to be free, or the page unit price for the interesting or important portion is set to be specially raised even if it is in the middle.

As shown in FIG. 12, even if, as shown in a region A, the unit price is partially lowered, or the unit price is partially raised, if there is a portion in which the unit price is gradually increased from the initial portion almost along with a basic curve X, although it is not a basic curve X itself, the curve is considered as the gradual increase from the initial portion in this application. In addition, even in a case where as shown in a region B, the unit price is partially set to be free in the middle, if there is also a portion in which the unit price is gradually increased from the initial portion along with the basic curve X, it is also considered as the gradual increase from the initial portion in this application.

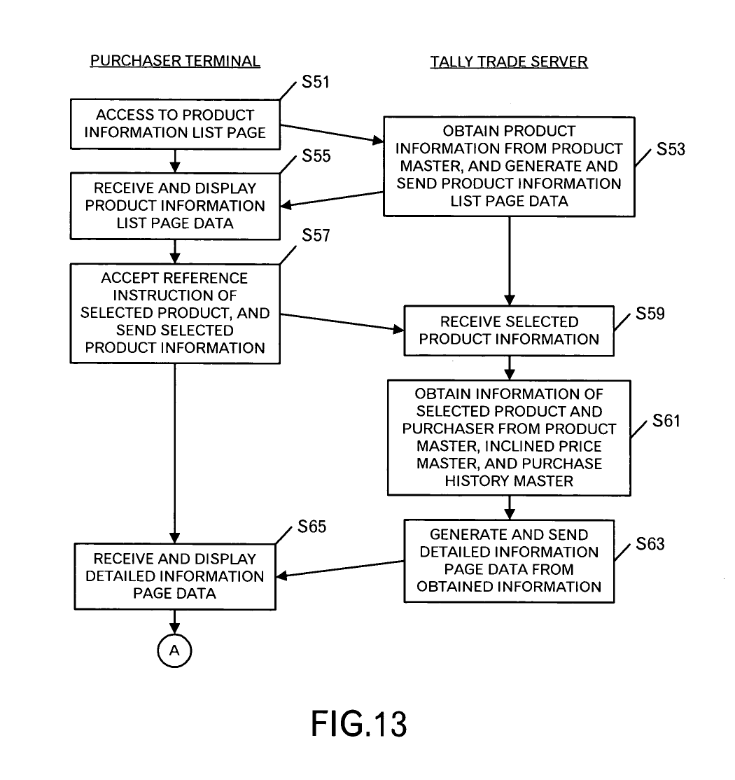

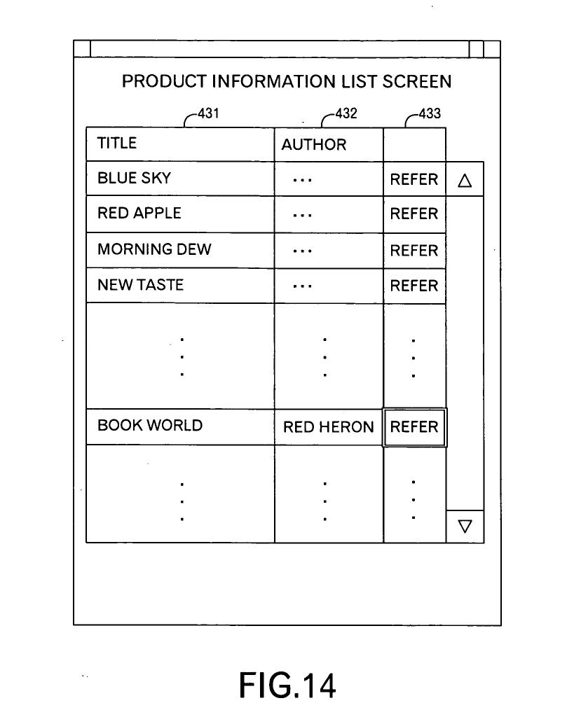

Next, a processing at the purchase of the contents will be explained using FIGS. 13 to 20. Although the processing is not shown in figures, it is assumed that the purchaser has already logged in the tally trade server 5 by using the purchaser terminal 3 of the purchaser. Then, the purchaser uses the purchaser terminal 3 to access the product information list page in the tally trade server 5 (step S51). In response to the access, the product information provider 53 of the tally trade server 5 obtains product information from the product master DB 64, generates the product information list page data, and transmits it to the purchaser terminal 3 (step S53). Incidentally, not only the product information is simply read out from the product master DB 64, but also it is possible to search the product master DB 64 according to keywords designated by the purchaser or personal attributes of the purchaser, which are registered in the member master DB 62. The purchaser terminal 3 receives the product information list page data from the tally trade server 5, and displays it on the display device by the Web browser (step S55). For example, a screen as shown in FIG. 14 is displayed.

In an example of FIG. 14, a product information list table is included, and in this table, a column 431 of titles, column 432 of authors, and columns 433 of refer buttons to display more detailed information are included.

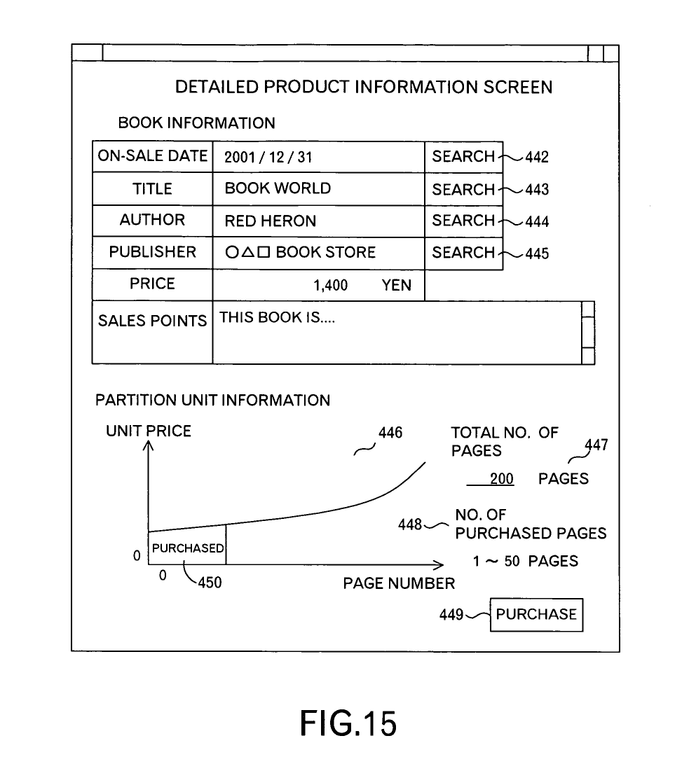

It is assumed that the purchaser clicks the refer button 434 in FIG. 14, here. Then, the purchaser terminal 3 accepts a reference instruction of the selected product by the click of the refer button 434, and transmits selected product information to the tally trade server 5 (step S57). The product information provider of the tally trade server 5 receives the selected product information, and temporarily stores it into a storage device (step S59). The product information provider 53 obtains information of the selected product and purchaser from the product master DB 64, inclined price master DB 63, and purchase history master DB 65 (step S61), generates detailed information page data by using the obtained information, and transmits it to the purchaser terminal 3 (step S63). The purchase terminal 3 receives the detailed information page data from the tally trade server 5, and displays it on the display device by the Web browser (step S65). For example, a screen as shown in FIG. 15 is displayed.

An example of FIG. 15 includes a table 441 of book information registered in the product master DB 64, search button 442 to search by the on-sale date in the book information, search button 443 to search by the title in the book information, search button 444 to search by the author in the book information, search button 445 to search by the publisher in the book information, display part 446 of a price graph of this book based on data registered in the inclined price master DB 63, display part 447 of the total number of pages registered in the product master DB 64, display part 448 of the number of purchased pages registered in the purchase history master DB 65, and purchase button 449. The example of FIG. 15 includes information of the purchased pages also in the display part 446 in the price graph.

By this display, the purchaser can obtain detailed information about the selected book, and also can confirm the price setting. In addition, in a case of the book the purchaser has partially purchased, because the purchased portion is also displayed, it is unnecessary for him or her to input the purchased portions up to the last time.

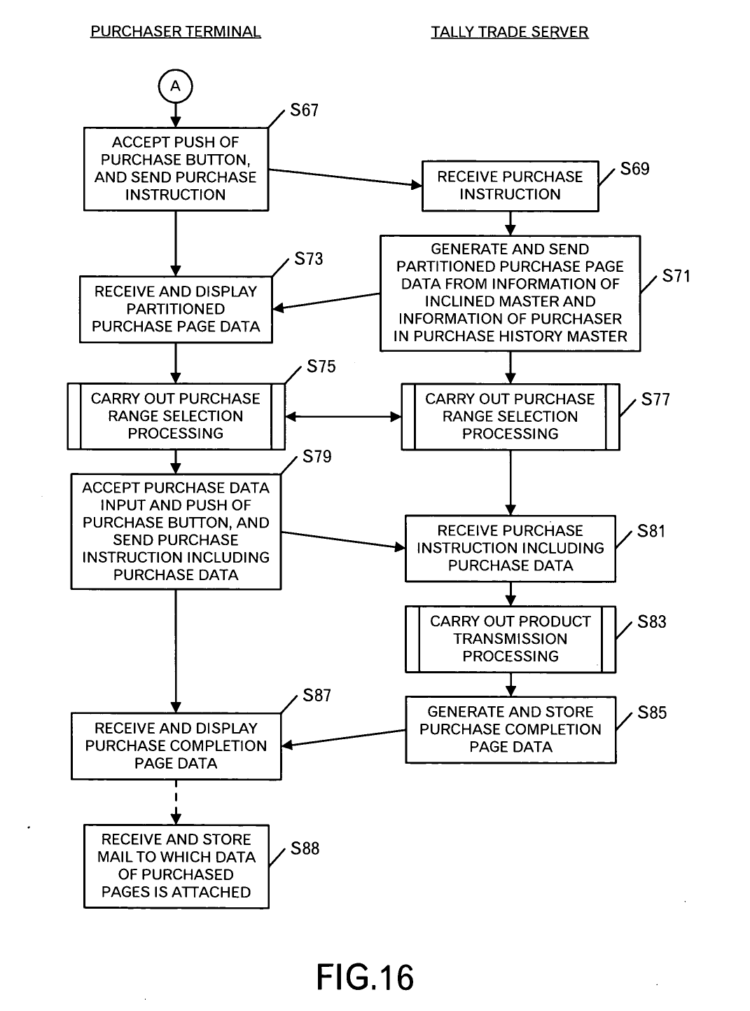

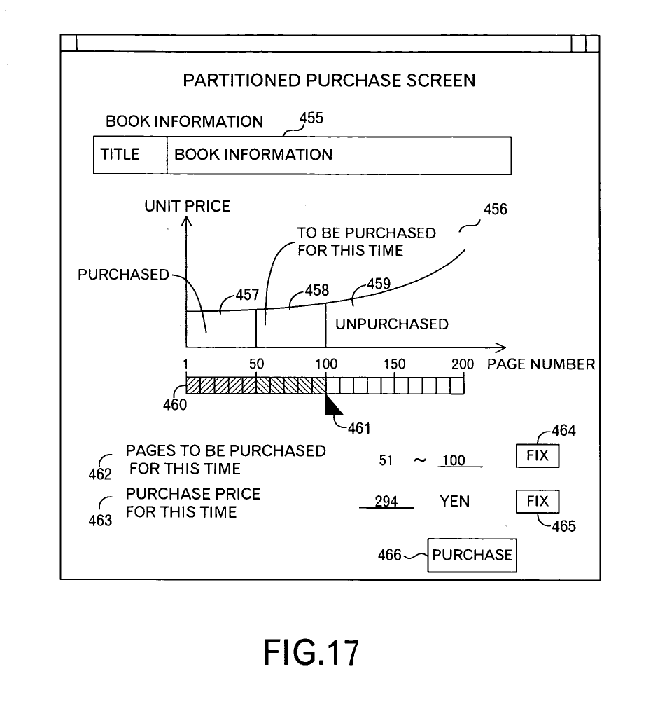

The processing shifts to a processing of FIG. 16 via a terminal A. Here, it is assumed that the purchaser clicks the purchase button 449 in the screen of FIG. 15. The purchaser terminal 3 accepts the push of the purchase button 449, and transmits a purchase instruction to the tally trade server 5 (step S67). The purchase processor 55 of the tally trade server 5 receives the purchase instruction from the purchaser terminal 3 (step S69). Then, the purchase processor 55 reads out information of the purchaser from the purchaser history master DB 65, and information concerning the price setting for this book from the inclined price master DB 63, and uses this information to generate partitioned purchase page data, and transmits it to the purchaser terminal 3 (step S71). The purchase terminal 3 receives the partitioned purchase page data from the tally trade server 5, and displays it on the display device by the Web browser (step S73). For example, a screen as shown in FIG. 17 is displayed.

An example of FIG. 17 includes a display column 455 of a title as the book information, display column 456 of a price graph, indicator 460 to specify pages to be purchased, lever 461 of the indicator 460, input and display column 462 of purchase pages for this time, input and display column 463 of the purchase price for this time, fix button 464 to cause the purchase price to be fixed from the purchase pages for this time, fix button 465 to cause the range of the purchase pages to be fixed from the purchase price for this time, and purchase button 466 to instruct the purchase. In the display column 456 of the price graph, a range 457 of purchased page range up to the last time, range 458 for which the purchase is instructed for this time, and non-purchased range 459 are indicated. Incidentally, according to the number of pages indicated by the lever 461 of the indicator 460 to specify pages to be purchased, the display of the range 458 for which the purchase is instructed for this time is changed. In the input and display column 462 of purchase pages for this time, the first page is automatically determined from the number of purchased pages, and it cannot be changed.

In addition, a Java applet or the like causes the display of the range 458 for which the purchase is instructed for this time to be changed, and causes display contents of the input and display column 463 of the purchase price for this time to be changed according to the movement of the lever 461 of the indicator 460 to specify the pages to be purchased.

The purchaser may fix the page to be purchased and purchase price for this time by shifting the lever 461 of the indicator 460, and may fix the purchase price by inputting the last purchase page into the input and display column 462 of the purchase pages for this time and clicking the fix button 464. In addition, it is also possible to input the purchase-desired price into the input and display column 463 of the purchase price at this time, and to click the fix button 465 to fix the range of the pages to be purchased.

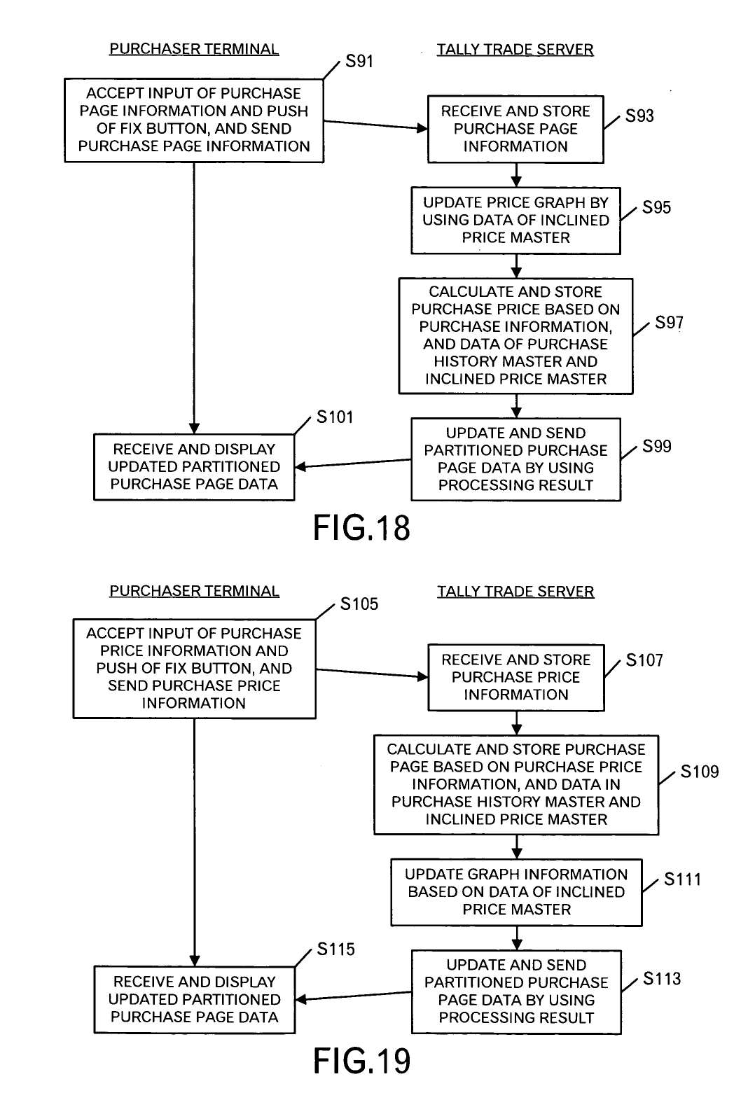

Here, a processing when the fix button 464 or 465 is clicked is explained as a purchase range selection processing by using FIGS. 18 and 19. FIG. 18 shows a processing when the fix button 464 is clicked. When the purchaser inputs the last page of the pages to be purchased for this time in the screen as shown in FIG. 17, and clicks the fix button 464, the purchaser terminal 3 accepts the input of the purchase page information and the push of the fix button 464, and transmits the purchase page information to the tally trade server 5 (step S91). The purchase processor 55 of the tally trade server 5 receives the purchase page information from the purchaser terminal 3, and temporarily stores it in a storage device (step S93). Then, it update the information of the price graph by using data of the pertinent book in the inclined price master DB 63 and the purchase page information, and stores it into the storage device (step S95). That is, the range 458 for which the purchase is instructed for this time is updated. In addition, the purchase processor 55 calculates the purchase price based on the purchase page information, data of the pertinent book and purchaser in the purchase history master DB 65, and the data of the pertinent book in the inclined price master DB 63, and stores it into the storage device (step S97).

At the processing of the step S97, the purchase price p is calculated according to the following equation by using the inclined price information including the information of the designated graph type (corresponding to the function f(x)), price change rate a and initial price b, recorded purchased end page g registered in the purchased history master DB 65 so as to correspond to the pertinent book and purchaser, and the last page h of the pages to be purchased at this time.
p−∫_{g+1}^{h}f(x)dx (8)
Incidentally, when the designated graph type indicates a quadric,
f(x)=ax²+b (9)
is used. Incidentally, Java applet or the like which is transmitted to the purchaser terminal 3 with the screen data as shown in FIG. 17 carries out the same calculation.

The purchaser processor 55 updates the partitioned purchase page data by the processing result of the aforementioned processing, and transmits the updated partitioned purchase page data to the purchaser terminal 3 (step S99). Here, the calculated purchase price is embedded into the input and display column 463 of the purchase price for this time, the received purchase pages (last page) is embedded into the input and display column 462 of the purchase pages for this time, and the updated price graph is embedded into the display column 456 of the price graph. The purchaser terminal 3 receives the updated partitioned purchase page data from the tally trade server 5, and displays it on the display device by the Web browser (step S101). By such a processing, the customer can know how much it costs only by designating the purchase range by myself.

On the other hand, FIG. 19 shows a processing when the fix button 465 is clicked. When the purchaser inputs the purchase price for this time in the screen as shown in FIG. 17, and clicks the fix button 465, the purchaser terminal 3 accepts the input of the purchase price information and the push of the fix button 465, and transmits the purchase price information to the tally trade server 5 (step S105). The purchase processor 55 of the tally trade server 5 receives the purchase price information from the purchase terminal 3, and temporarily stores it into a storage device (step S107). Then, the purchase processor 55 calculates data for a purchase page based on the purchase price information, data of the pertinent book and purchaser in the purchase history master DB 65, and data of the pertinent book in the inclined price master DB 63, and stores it into the storage device (step S109).

At the processing of the step S109, the last page j for this purchase is calculated according to the following equation by using the inclined price information including the information of the designated graph type (corresponding to the function f(x)), price change rate a and initial price b, which is stored in the inclined price master DB 63, recorded purchased end page g registered in the purchased history master DB 65 so as to correspond to the pertinent book and purchaser, and the purchase price p designated for this time.
∫_{g+1}^{j}f(x)dx=p (10)

Incidentally, when the designated graph type indicates the quadric, it means
f(x)=ax²+b (11)
Incidentally, the Java applet or the like that is transmitted to the purchaser terminal 3 with the screen data as shown in FIG. 17 also carries out the same processing.

Then, the purchase processor 55 updates information of the price graph by using the price setting information (inclined price information) for the pertinent book in the inclined price master DB 63, and stores it into the storage device (step S111). That is, the range 458 for which the purchase is instructed for this time is updated by the purchase page information calculated at the step S109.

The purchase processor 55 updates the partitioned purchase page data by the processing result of the aforementioned processing, and transmits the updated partitioned purchase page data to the purchaser terminal 3 (step S113). Here, the designated purchase price is embedded into the input and display column 463 of the purchase price for this time, and the calculated purchase page (last page) is embedded into the input and display column 462 of the purchase pages for this time, and the updated price graph is embedded into the display column 456 of the price graph. The purchaser terminal 3 receives the updated partitioned purchase page data from the tally trade server 5, and displays it on the display by the Web page (step S115). By carrying out such a processing, it becomes possible to automatically know a range which can be purchased when the budget is determined, for example. Incidentally, fractions may occur according to the price setting. Therefore, it may be necessary to re-calculate the purchase price according to the calculated purchase pages.

Returning to the explanation of FIG. 16, the purchaser carries out a selected range selection processing (steps S75 and S77), and determines the purchase range by the Java applet or the like in FIG. 17. Then, he or she clicks the purchase button 466 in FIG. 17 in a state in which the purchase pages and purchase price are input. The purchaser terminal 3 accepts the input of the purchase data including the purchased pages and purchase price, and the push of the purchase button 466, and transmits a purchase instruction including the purchase data to the tally trade server 5 (step S79).

The purchase processor 55 of the tally trade server 5 receives the purchase instruction from the purchaser terminal 3, and temporarily stores it into a storage device (step S83). Then, the product transmission processor 57 carries out a product transmission processing (step S83). This processing will be explained later in detail.

Finally, it generates the purchase completion page data, and transmits it to the purchaser terminal 3 (step S85). The purchaser terminal 3 receives the purchase completion page data from the tally trade server 5, and displays it on the display device by the Web browser (step S87). Incidentally, because data of the purchased pages is transmitted at the step S83 via mail as described later, a mailer receives the mail to which data of the purchased pages is attached at a predetermined timing, and stores it into a storage device (step S88). Thus, the purchaser can read the purchased pages.

By carrying out such a processing, the partitioned purchase of the book is enabled. Especially, it is possible that the purchaser can purchase the initial portion at a low price, and can judge based on the initial portion, whether or not the purchase should be continued. In addition, if he or she determines that he or she does not like it at the early stage, it is possible to suppress the paid amount to lower than the amount when purchasing all portions. On the other hand, for the seller, the obstacle in the online sales of the book becomes lower, and the purchase by the customer is promoted. In addition, the seller can obtain the same sales amount as the conventional one when the purchaser buys the entire contents, and even if the purchaser stopped his or her purchase halfway, the contents seller can obtain the sales amount for the purchased portions.

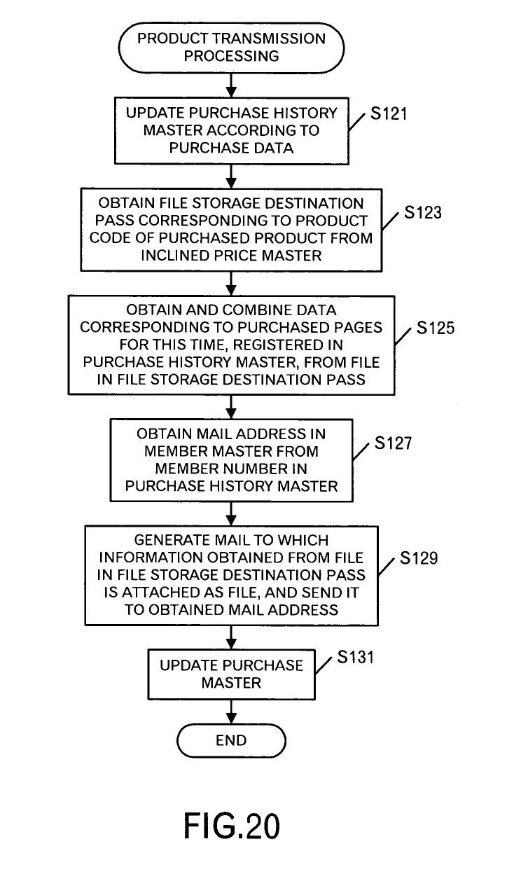

The details of a processing at the step S83 by the product transmission processor 57 of the tally trade server 5 will be explained using FIG. 20. The product transmission processor 57 updates the purchase history master DB 65 according to the purchase data including the purchased pages and purchase price (step S121). It registers the member number, product code, recorded start page, recorded end page, purchase start page for this time, purchase end page for this time, and purchase price for this time. However, it may carry out a processing for the received purchase data to confirm the purchase price corresponding to the purchased page range.

Next, it obtains the file storage destination pass corresponding to the product code of the purchased product from the inclined price master DB 63 (step S123), obtains data corresponding to the purchased page range for this time, which is registered in the purchase history master DB 65, from the file in the file storage destination pass, forms a file by combining the obtained data, and stores it into a storage device (step S125). In addition, it obtains a mail address in the member master DB 62 from the member number registered in the purchase history master DB 65 (step S127), generates a mail to which a file formed from the file of the file storage destination pass is attached, and transmits it to the obtained mail address (step S129). Then, it updates the purchase master DB 61 (step S131). That is, it stores the member number of the purchaser relating to the purchase for this time, product code, purchase type (purchase start page for this time+A+purchase end page for this time), and purchase price, and sets the bill flag to not paid.

Incidentally, as for the purchase master DB 61, the bill flag is set to “1” when the payment is confirmed in another processing.

As described above, the purchaser can obtain information of the purchased pages and read the contents by using another program or the like.

Incidentally, although such a configuration in which data is transmitted via mail is indicated in FIG. 20, the data may be directly downloaded in the processing flow in FIG. 16.

Although an embodiment of this invention is explained, this invention is not limited to this. For example, although an example in which the tally trade server 5 is configured by one computer is shown in FIG. 1, the aforementioned functions may be configured by plural computers. In addition, respective processors of the tally trade server 5 may not correspond to respective program modules. Furthermore, as for the DB configuration, FIG. 1 is an example, and other DB configuration may be adopted. In addition, although an example in which information of the contents to be sold is registered by the seller terminal 7, an administrator of the tally trade server 5 may register it on behalf of the seller.

Furthermore, the screen configurations described above are mere examples, and other screen configurations including the same contents may be adopted. In addition, one screen described above may be divided into plural screens and the plural screens may be presented to the purchaser or seller.

1. A contents tally trade sales method, comprising:
when receiving information to specify a purchase portion of contents that are priced so that a portion whose sales unit price gradually increases from a sales unit price of an initial portion exists, and a purchase instruction from a terminal of a purchaser, registering information concerning a purchase range of said contents and price information into a storage device so as to correspond to said purchaser; and
transmitting data for said purchase portion of said contents to said purchaser.

2. The contents tally trade method as set forth in claim 1, wherein said information to specify said purchase portion of said contents comprises information of a purchase price, and said registering comprises computing said information concerning said purchase range of said contents from said information of said purchase price and information concerning a price setting of said contents.

3. The contents tally trade method as set forth in claim 1, wherein said information to specify said purchase portion of said contents comprises said information concerning said purchase range of said contents, and said registering comprises computing price information of said contents from said information concerning said purchase range of said contents and said information concerning a price setting of said contents.

4. The contents tally trade method as set forth in claim 1, wherein transmitting information concerning a last purchase range or information concerning a purchase range up to a last purchase, to said terminal of said purchaser, by using said information concerning said purchase range of said contents, which is registered in said storage device.

5. The contents tally trade method as set forth in claim 1, further comprising: transmitting to said terminal of said purchaser, information to display a price graph based on a price setting of said contents and a purchase range up to a last purchase by using said price graph and said information concerning said purchase range of said contents, which is registered in said storage device.

6. The contents tally trade method as set forth in claim 1, further comprising: transmitting to said terminal of said purchaser, data to prompt a purchase of said contents, wherein said data enables to specify portions after a purchase range up to a last purchase as said information to specify said purchase portion of said contents by using said information concerning said purchase range of said contents, which is registered in said storage device.

7. A contents purchase method, comprises:
receiving from a contents sales server and display on a display device, information concerning a price setting of purchase-desired contents that are priced so that a portion whose sales unit price gradually increases from a sales unit price of an initial portion exists, and information concerning a purchase range up to a last purchase of said purchase-desired contents;
accepting from a user and transmitting to said contents sales server, information to specify a purchase portion of said purchase-desired contents; and
receiving said purchase portion of said purchase-desired contents, which is generated by said contents sales server.

8. A contents sales setting method, comprising:
when receiving a registration request of sales contents from a terminal of a seller, transmitting data to prompt a price setting of said sales contents to a terminal of a seller; and
when receiving instruction information of said price setting for said sales contents, in which a portion whose sales unit price gradually increases from a sales unit price of an initial portion exists, storing information concerning said price setting for said sales contents.

9. The contents sales setting method as set forth in claim 1, further comprising: transmitting to said terminal of said seller, model data for price curves of said sales contents, which includes a price curve of said price setting in which a portion whose sales unit price gradually increases from a sales unit price of an initial portion exists.

10. The contents sales setting method as set forth in claim 1, wherein said instruction information of said price setting for said sales contents comprises instruction information for a parameter of said price curve, and
said contents sales setting method further comprising:
transmitting to said terminal of said seller, data to prompt an instruction for said parameter of said price curve.

11. A contents sales setting method, comprising:
receiving data to prompt a price setting of sales contents from a contents sales server that is a transmission destination of a registration request of said sales contents; and
accepting from a seller and transmitting to said contents sales server, information for said price setting for said sales contents in which a portion whose sales unit price gradually increases from a sales unit price of an initial portion of said sales contents exists.

12. A program embodied on a medium, executed by a computer, said program comprising:
when receiving information to specify a purchase portion of contents that are priced so that a portion whose sales unit price gradually increases from a sales unit price of an initial portion exists, and a purchase instruction from a terminal of a purchaser, registering information concerning a purchase range of said contents and price information into a storage device so as to correspond to said purchaser; and
transmitting data for said purchase portion of said contents to said purchaser.

13. A program embodied on a medium, executed by a computer, said program comprising:
when receiving a registration request of sales contents from a terminal of a seller, transmitting data to prompt a price setting of said sales contents to a terminal of a seller; and
when receiving instruction information of said price setting for said sales contents, in which a portion whose sales unit price gradually increases from a sales unit price of an initial portion exists, storing information concerning said price setting for said sales contents.

14. A contents tally trade apparatus, comprising:
a registering unit that registers information concerning a purchase range of contents and price information into a storage device so as to correspond to a purchaser, when receiving information to specify a purchase portion of said contents that are priced so that a portion whose sales unit price gradually increases from a sales unit price of an initial portion exists, and a purchase instruction from a terminal of said purchaser; and
a unit that transmits data for said purchase portion of said contents to said purchaser.

15. A contents sales setting apparatus, comprising:
a transmitter that transmits data to prompt a price setting of sales contents to a terminal of a seller, when receiving a registration request of said sales contents from said terminal of said seller; and
a unit that stores information concerning a price setting for said sales contents, when receiving instruction information of said price setting for said sales contents, in which a portion whose sales unit price gradually increases from a sales unit price of an initial portion exists.
